(19) United States
(12) Patent Application Publication
(10) Pub. No.: US 2018/0178062 A1
(43) Pub. Date: Jun. 28, 2018

(54) DEVICE FOR CONTROLLING PHYSICAL TRAINING

(71) Applicant: SYNERGY MOVEMENT TECHNOLOGIES 3000 SL, Granada (ES)

(72) Inventor: Ignacio CHIROSA RIOS, Granada (ES)

(21) Appl. No.: 15/565,284

(22) PCT Filed: Apr. 8, 2016
(86) PCT No.: PCT/ES2016/070239

§ 371 Date: Mar. 9, 2018

(30) Foreign Application Priority Data
Apr. 9, 2015 (ES) U201530402

(51) Int. Cl. A63B 24/00; G09B 19/00; A63B 21/005; A63B 71/06

(52) U.S. Cl. CPC A63B 24/0062; G09B 19/0038; G09B 19/003; A63B 24/0087; A63B 2230/60; A63B 21/0058; A63B 71/0622; A63B 2220/40; A63B 21/0053

(57) ABSTRACT

A device for controlling physical training, which comprises: a dynamometric element for the evaluation, diagnosis and development or stimulation of different manifestations of force; a workstation that can be connected to the dynamometric element, which is configured as a multifunctional modular structure suitable for location on floors and walls; and a plurality of sensors; in which all these elements are connected to a processor element.

The objective of this invention is a device for the control and modulation of physical training or therapy by means of movement and which integrates various elements, the purpose of which is the control, management and tracking of human movement, comprising a plurality of sensors that measure the various parameters involved in exercise or physical training.

### STATE OF THE ART

The existence of a plurality of apparatus and instruments is known that are used for this purpose, the control and modulation of physical training/therapy through movement within the various areas, such as rehabilitation, injury prevention and sports training. Said instruments or apparatus are specially designed to only cover the analytic stages of the rehabilitation process and reproduce closed exercise forms that are non-functional and conventional.

In a similar fashion, numerous apparatus, machines and equipment are known in the physical and sports training areas which, although they seek similar ends, they have a series of technical deficiencies and problems that are resolved by this invention.

Similarly, there is no information about the existence of apparatus or devices that reproduce and generate natural controlled human movement as a pillar for achieving goals of evaluation, treatment and rehabilitation in a versatile, adaptive manner that is easy to use and covers all the process stages of rehabilitation, physical re-adaptation and programs of physical conditioning with respect to health and performance.

### DESCRIPTION OF THE INVENTION

One objective of the invention is to resolve the problems mentioned in the state of the art. To this end, in addition to the conventional isokinetic exercises, the device covered by this invention also allows the reproduction of a wide range of pleokinetic, isotonic, pleotonic, inertial and isoinertial exercises. These exercises are also evaluated and monitored by the actual device through a plurality of performance parameters.

This invention resolves these problems in accordance with the first claim that accompanies this description. Particular embodiments of this invention are described in the depending claims. They are all incorporated in this description for reference.

Thus, this invention essentially consists of:
a) a plurality of sensors, particularly piezoelectric sensors or other elements that record kinetic and kinematic parameters of the movements of articulations and mechanical levers of the human body, and
b) elements configured to regulate the external resistance that a muscle or set of muscles must overcome, maintain or simply allow to move.

All this set of elements join together to create a device or tool capable of performing a functional evaluation, diagnosis and treatment during physical training or in a session of physical exercise for therapeutic reasons.

One special feature of this invention lies in its capability of performing controlled natural movement. This means that, when using devices that regulate the external resistance, movement patterns of basic human motor skills can be reproduced and generated and pleokinetic movements are produced. This form of manifestation of the movement or motor skills is considered a significant advantage over the state of the art because it allows multiple objectives to be achieved in terms of evaluation, diagnosis and treatment or therapeutic intervention.

Another advantage is that the device of this invention serves to monitor different types of training or physical fitness sessions, whether general or specific, regardless of the sports or therapeutic equipment being used. These sensors are used to record all the actions of a muscle or group of muscles that are working during a given period. In addition, one or more subjects can be monitored in the same session and this enables the tracking of one or various sessions over time.

Throughout the description and claims, the word “comprises” and its variations do not involve the exclusion of other technical specifications, additions, components or steps. For those skilled in the art, other objects, advantages and characteristics of the invention, will be clear partly from the description and partly from the invention in use. The following examples and drawings are provided for illustrative purposes only and are not intended to restrict this invention in any way. Moreover, this invention covers all possible embodiment combinations, particular and preferred, indicated here.

### BRIEF DESCRIPTION OF THE DRAWINGS

A very brief description of a series of drawings follows, which will help to better understand the invention and which expressly relate to an embodiment of this invention that is presented as non-limiting example of this.

FIG. 1 shows the schematic of the elements that integrate the device covered by the invention.

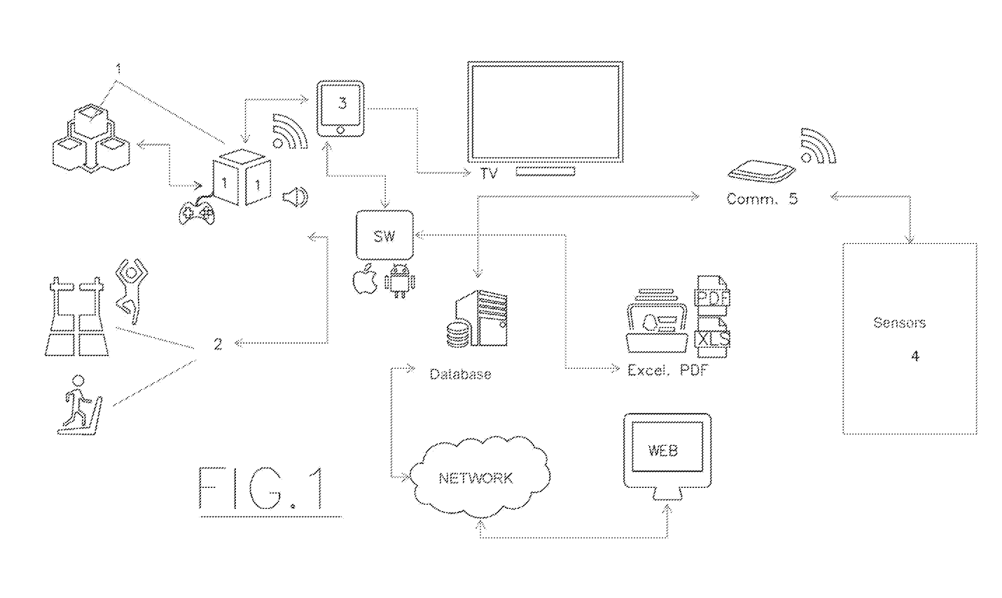

FIG. 2 shows an elevation view of the components that integrate the device covered by the invention.

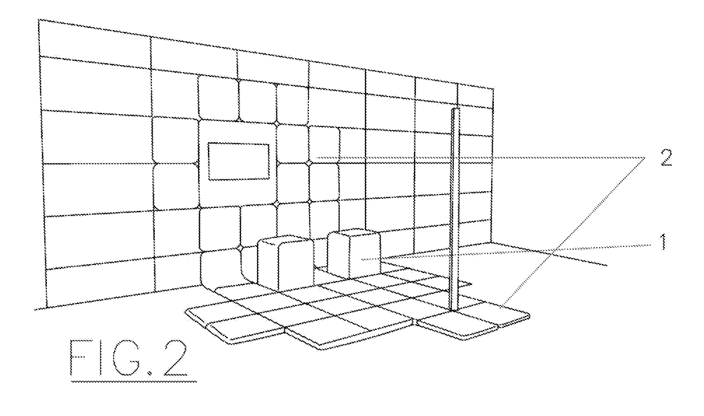

### DETAILED EMBODIMENT OF THE INVENTION

The device of the invention consists of a series of integrated and interconnected elements. These elements, in accordance with the accompanying figures are described below.

The device of the invention comprises a dynamometric element 1 for evaluation, diagnosis and development or stimulation of the various manifestations of the force. This dynamometric element 1 comprises one or more electric motors (electric dynamometer rotor), which is coupled to a mechanical gearbox and can provide the necessary torque. To achieve this harmonically regulated torque result, a controller is employed with a high-performance processor, together with a relay board that controls the required motor currents. To achieve a high degree of precision and control of movement, an embedded PC is incorporated that regulates the communication protocols between the various devices that make up the invention. The correct integration of various sensors (those inside the dynamometric element as well as outside that communicate with it) is the key for reproducing any kind of movement. Taken all together, it can reproduce and control the kinetics and cinematically any gesture or basic motor action in daily life and in sport in various types of persons.

This dynamometric element 1 is connected to a workstation 2 which is configured as a multifunctional structure that enables it to be located or connected on the floor or the wall and facilitates the inclusion of various required accessories for any intervention program. These accessories can be classified as: accessories for securing, stabilisation, and position control or the securing of reference systems. Among these, mention should be made of the structure that delimits the workspace and allows work on it. The floor on which the exercises are performed has the main practical characteristic of versatility. Being modular enables various workspaces to be configured and, in turn, facilitates the inclusion of pulleys, rails and masts, etc, which make it possible to comply with the needs of standardisation and reproducibility of any human gesture. The goal is to control human mechanics in any of the previously mentioned areas.

In the same way, both sensors and accessories may be located on walls and ceilings to facilitate practice so far described.

Finally, the device is completed by a multifunction signal receiver (wireless control station 5), which enables integration of a plurality of sensors 4, but not limited to: goniometers, encoders, strain gauges, photocells, accelerometers, electromyographers, electro-stimulators, or any other sensor capable of being incorporated to measure a particular human muscular mechanics parameter as applied to sport or therapy through movement.

All elements are connected to a processor element 3, such as a portable electronic device defined as an electronic device that comprises an screen, preferably a touch screen; one or more processors; a memory; and one or more programs, in which the program or programs are stored in the memory and configured for execution by means of one or more processors; characterised in that the programs include instructions for integrating the previously described elements for programming, scheduling, performing and recording any action, task, exercise and one or more sessions. It is, therefore, a basic tool for managing intervention programs, in any of the operating areas that are being worked, for example, health, sports performance and training of professionals in the workplace, among others.

The device thus described, achieves the basic objective of this invention, in other words, the control, management and monitoring of human movement during physical training.

1. A device for controlling physical training which is characterized in that it comprises: a dynamometric element for the evaluation, diagnosis, development or stimulation of the various manifestations of force that can be connected to a workstation that is configured as a multifunctional, modular structure suitable for location on floors and walls; and a plurality of sensors; where all these elements are connected to a processor element.

2. The device according to claim 1, in which the dynamometric element comprises at least one electric dynamometer rotor coupled to a mechanical reduction gearbox, all regulated by an embedded PC.

3. The device according to claim 1, in which the workstation comprises a plurality of securing, stabilisation accessories and accessories for position control or securing of reference systems.

4. The device according to claim 1 wherein the plurality of sensors comprises at least one of the following: goniometers, encoders, strain gauges, photocells, accelerometers, electromyographers, electrical stimulators and any sensor that can be incorporated for measuring a determined parameter of human muscular mechanics applied to sport or therapy through movement; or a combination thereof.

5. The device according to claim 1, in which the processor element is a portable electronic device comprising a screen, preferably a touch screen; one or more processors; a memory; and one or more programs, in which the program or programs are stored in the memory and configured to run on one or more processors; and where programs include instructions for: integrating the dynamometric element, the workstation and a plurality of sensors; and programming, scheduling, performing and recording any action, task, exercise and one or more sessions.
